(19) United States
(12) Patent Application Publication
(10) Pub. No.: US 2013/0055923 A1
(43) Pub. Date: Mar. 7, 2013

(54) STAINS, COATINGS, AND SEALERS

(71) Applicant: Robert Lawrence Benson, Lombard, IL (US)

(72) Inventor: Robert Lawrence Benson, Lombard, IL (US)

(21) Appl. No.: 13/410,676

(22) Filed: Mar. 2, 2012

Related U.S. Application Data
(63) Continuation of application No. 12/877,450, filed on Sep. 8, 2010, now abandoned.

(51) Int. Cl. C08L 75/04; C08K 5/098; C08K 5/01; C08K 5/205; C08L 33/10; C08K 5/101; C08K 3/22; C09D 191/00; C08K 13/02

(52) U.S. Cl. 106/18; 106/250; 106/251; 523/122; 524/398; 524/590

(57) ABSTRACT

A composition for treating wood, concrete, masonry and related materials to effect sealing the article against water, preventing microbial attack, protecting against UV degradation, and optionally imparting a color for aesthetic purposes and an article treated with the composition. The composition includes a solvent having an elevated flash point, no VOC's or substantially no VOC's, and the composition can be used inside with little or no additional ventilation. The compositions contain no antioxidants, or low and controlled levels of antioxidants to allow the applied composition to properly oxidize and cure upon exposure to air. The compositions can be applied by all conventional methods known for applying sealants and stains.

The present application is a continuation of U.S. application Ser. No. 12/877,450 filed Sep. 8, 2010, claiming priority to U.S. application Ser. No. 12/579,676 filed Oct. 15, 2009, claiming priority to U.S. Provisional Application No. 61/105,612, filed Oct. 15, 2008, entitled “Stains, Coatings and Sealers.” The subject application claims priority to U.S. application Ser. No. 12/877,450, U.S. application Ser. No. 12/579,676 and U.S. Provisional Application No. 61/105,612 and incorporates all by reference herein, in their entirety.

### FIELD OF INVENTION

The present invention relates to penetrating oil-based stains, coatings and sealants, which upon application cure, and provide the surface with protection against the effects of UV, moisture, color fading and release no volatile organic compounds or substantially no volatile organic compounds (VOC's) during or after application. Additionally, certain of the compositions protect a treated surface from attack by a variety of microorganisms including, but not limited to algae, fungi, and bacteria.

### BACKGROUND

Currently available stains and coatings are generally oil-based or water-based systems. Although the water-based systems offer advantages of generally no VOC's (“volatile organic compounds”), their ability to penetrate a wood surface and provide a pleasing finish have been limited. Oil-based stains and coatings generally provide better penetration, water repellency, and durability, but suffer from the release of VOC's, typically the solvent, upon application. The release of VOC's are problematic because of odor and for environmental and safety reasons. For example, their use in an exterior location creates environmental problems. Their use in an interior location requires proper and sufficient ventilation to avoid both odor build-up and explosive, toxic and otherwise unsafe conditions. The continued release of VOC's for days after an indoor application can provide a continuing odor problem after continued ventilation becomes impractical and less important for safety reasons. In addition, the currently available water-based or oil-based stains and coatings do not include a completely non-toxic inorganic agent to provide the desired long-term UV protection necessary to maintain the stain or coating's original color and protect the treated surface from UV derived degradation. Currently available sealants utilizing low VOC solvents are based on solvents containing substantial amounts of antioxidants to protect the solvents. Sealants and/or stains utilizing solvents containing antioxidants fail to cure and provide the necessary surface protection. Finally, the currently available sealants, stains and coatings fail to provide a treated surface with the additional protection against a broad range of microbial attack encountered in many environments.

What is needed is a stain or coating providing the desirable appearance of an oil-based stain that can be used to treat interior or exterior wood surfaces without generating unhealthy and undesirable volatiles and that will maintain the treated surface's color even when exposed to UV light. The UV protection for the applied stain or coating should be attainable by the addition of one or more non-volatile and non-toxic inorganic materials. In addition, the stain or coating should also have a long shelf-live and protect a treated surface treated from attack by microorganisms such as bacteria, fungi and algae and be capable of properly curing within a reasonable time upon application and exposure to air. Additionally needed is a concrete sealer that can be used to treat interior or exterior concrete surfaces, similarly, without generating unhealthy and undesirable volatiles and be capable of providing a natural concrete appearance. The concrete sealer should be capable of curing within a reasonable time upon application and exposure to air. Upon curing the applied sealer should be capable of protecting the surface from the adsorption of water and any dissolved materials that can weaken and damage concrete and further be capable of protecting the treated concrete surface from damage from the normal freeze-thaw cycle. The present disclosure addresses these needs.

### SUMMARY

The present disclosure relates to low and/or no VOC, penetrating stain, coating and sealing compositions for staining, coating, and/or sealing and otherwise protecting porous surfaces such as wood, concrete, cement, brick and the like which are capable of fully curing upon application and exposure to air. In particular, this disclosure relates to stable dispersions of oil-based stains and sealers having low or no VOC's and which are substantially free of antioxidants. The stains and sealers of this disclosure are particularly useful as environmentally compliant coatings, penetrating stains and water sealants that can protect a treated surface from the effects of UV light, microorganisms, moisture, and the like.

Aspects of the present invention provide the superior performance of an oil-based stain or coating and can be utilized for interior and exterior application without generating toxic and/or flammable vapors. When used to coat wooden surfaces, a natural wood color can be obtained without out sacrificing water repellency, durability, or a natural wood appearance. When used to seal concrete surfaces, a natural concrete surface can be obtained or pigments can be included to provide alternative colorations. As used herein, “oil-based” does not require the solvent to have been produced from a petroleum product, but only requires the solvent to be non-aqueous and compatible with a variety of common petroleum solvents and have some similar solvent properties. This definition is consistent with current usage in the coatings industry.

Penetrating finishes, are designed to protect a substrate, and optionally change a substrate's color, yet retain the natural textural appearance of the substrate. Penetrating pigmented stains, non-pigmented wood preservatives, and water sealants are typical examples of penetrating finishes. One key attribute of penetrating finishes is that they are designed so as not to form an appreciable surface film or coating on the wood/substrate. They are typically solutions or dispersions of very finely ground components, such as for example, pigments. Such finishes can be formulated to be durable, well suited for textured, exposed surfaces such as siding, decks, steps and the like, can contain water repellants, and are easily applied.

With the advent of environmental laws and regulations controlling the maximum amounts of VOC permitted in paints, coatings, stains, sealants and the like, numerous attempts have been made in the prior art to formulate coatings and stains which comply with the VOC requirements. In addition, interior and exterior stained surfaces exposed to UV light fade over a period of time making re-application of the stain necessary. Attempts to resolve the environmental issues by developing water-based stains has provided stains having low VOC's at the expense of a natural wood appearance and has not adequately addressed the fading issue caused by exposure to UV light. Similarly, attempts to develop non-aqueous sealants having low VOC's have sacrificed both appearance and performance.

Certain aspects of the present invention relate to stable, substantially clear and colorless oil-based sealants containing UV stabilizers to prevent fading of treated surfaces. Other aspects additionally contain one or more pigments to provide color to the resulting stain. The solvents utilized in all coatings have no VOC's or substantially no VOC's and flash points (elevated flash points) substantially above typical ambient interior and exterior temperatures.

Substantially no VOC's refers to a level of volatile emissions from a composition that, although not zero, is sufficiently low as to be negligible. Non-volatile solvents having no VOC's typically exhibit a vapor pressure of less than about 2 mmhg at 20° C., whereas substantially non-volatile solvents having substantially no VOC's typically exhibit a vapor pressure at 20° C. of less than about 5 mmhg. For the purposes of this disclosure, a solvent or a composition having no VOC's is also considered to have substantially no VOC's. In other words, having no VOC's is a subset of having substantially no VOC's. Solvents having elevated flash points typically exhibit flash points (TCC) of at least about 50° C.

Coatings and stains having elevated flash points and no VOC's or substantially no VOC's are generally safe to use in closed indoor locations and outside and can generally be used for interior applications with little or no ventilation. Other aspects of the present invention relate to stable, oil-based stains or coatings containing dispersions of pigments and UV stabilizers dissolved and/or dispersed in solvents having no VOC's. Formulations having no VOC's are formulated with solvents having a vapor pressure of less than about 2 mmhg at 20° C.; formulations having substantially no VOC's are formulated with solvents having a vapor pressure of less than about 5 mmhg at 20° C.; and formulations having elevated flash points are formulated with solvents having flash points (TCC) of at least about 50° C. or above. Still other aspects of the present invention relate to concrete or masonry sealers, having substantially no VOC's, which upon application can provide a natural or altered concrete or masonry appearance.

Solvents and other components of the present compositions of this disclosure should be free or substantially free of antioxidants typically added to minimize oxidation during storage and shipping of the solvent. The presence of antioxidants, at the levels utilized to protect commercial grades of solvents from oxidation, can interfere with the drier induced polymerization/crosslinking of the applied sealant or stain necessary to effect curing of the sealant or stain. Failure of the sealant or stain to properly cure causes the applied sealant/stain to remain fluid. In this fluid, uncured state the applied sealant/stain can, depending on the porosity of the surface being treated become tacky and/or wick back into a contacted porous material such as a dresser scarf, clothing and the like, resulting in staining/discoloration of the porous material. A composition is substantially free of antioxidants if the formulation will cure to form a non-fluid material within about 24 to 48 hours.

For example, commercially available methyl soyate typically contains hydroquinone or a hydroquinone derivative in sufficient amounts to interfere with the drier causing the surface treated with the sealant/strain to remain fluid, causing a treated surface to remain tacky or wet. Commercially sources of limonene typically contain an anti-oxidant, the presence of which upon inclusion into a formulation interferes with the performance of a drier. As a result the treated surface can remain wet and tacky. Sealants/stains formulated with methyl soyate or limonene containing this or a similar antioxidant at the levels typically found in the commercially available solvent fail to adequately cure and remain fluid in treated porous surfaces. Because the amount of antioxidant that can be tolerated in the sealant/stain depends on the specific antioxidant and its antioxidant properties, no maximum level can be stated that is applicable to all antioxidants.

The dispersions of this disclosure have excellent abrasion resistance, shelf stability, resistance to microbial degradation, penetration into porous surfaces and UV light stability. These dispersions are particularly suited for use, either alone or with additional ingredients such as pigments, waxes and the like, as surface coatings, penetrating stains and sealants. The coatings, stains, and sealants of the present disclosure can be applied by all common application methods used for stains, sealants, and coatings.

A first aspect of the present disclosure involves a non-aqueous sealant that includes substantially non-volatile solvent having an elevated flash point, a UV protectant, at least one resin, at least one drier, and a biocide. Components of the sealant are sufficiently free of antioxidants to allow the resulting composition to cure normally upon application and exposure to air. For preferred compositions, such curing generally occurs within about 24 to 48 hours of application. Particularly useful solvents include methyl soyate and limonene. Particularly preferred compositions typically cure within about 24 hours of application at normal temperatures and conditions. A non-aqueous sealant or stain does not have to be anhydrous, but typically contains no more than very minor levels of water in a homogeneous liquid phase. Although UV protectants and biocides are not required, sealers suitable for application to concrete surfaces can include one or both.

A further aspect of the present disclosure involves a non-aqueous stain that includes a substantially non-volatile solvent having an elevated flash point, a UV protectant, at least one resin, a pigment, at least one drier, and a biocide. Components of the sealant are sufficiently free of antioxidants to allow the resulting composition to cure upon application and exposure to air. Particularly preferred and useful solvents include methyl soyate and limonene.

A still further aspect of the present disclosure involves an article treated with a non-aqueous composition containing a substantially non-volatile solvent having an elevated flash point, a UV protectant, at least one resin, at least one drier, and a biocide and an optional pigment. Components of the sealant are sufficiently free of antioxidants to allow the resulting composition to cure upon application and exposure to air. Particularly useful solvents include methyl soyate and limonene. Examples of articles which can be treated with the formulations of the present disclosure include, but are not limited to outdoor furniture, decks, buildings (interior and exterior), portions of buildings, and the like and the articles can be constructed from porous materials which include, but are not limited to wood, wood products, concrete, and the like.

A still further aspect of the present disclosure involves a surface treated with a non-aqueous composition containing a substantially non-volatile solvent having an elevated flash point, at least one resin, at least one drier, and a cross-linker. Components of the sealant are sufficiently free of antioxidants to allow the resulting composition to cure upon application and exposure to air, and can optionally contain a UV protectant, a biocide, one or more pigments or colorants, and other additives. Limonene is a particularly useful solvent for use in the concrete sealer.

### DESCRIPTION

The compositions of this disclosure are surface coatings, penetrating stains and sealants which can comprise stable dispersions of insoluble components such as small particle size pigments and/or UV stabilizers in a non-aqueous media providing no VOC's or low VOC's. The sealant compositions according to this disclosure generally contain a UV protectant, a solvent, one or more driers, resins, and one or more biocides to prevent the growth of molds, algae, and the like on a treated surface. Sealant compositions can similarly contain dissolved components and be formulated with or without pigments, UV stabilizers, and one or more biocides. The stain compositions additionally contain one or more pigments to provide coloration. Because the compositions of this present disclosure are oil-based, the various components utilized, must either have sufficient solubility or be capable of being dispersed in the non-aqueous system in the amounts necessary to provide the desired effect as described below.

The non-aqueous media or solvent system utilized for dispersing and/or dissolving the other components generally include one or more nonvolatile or substantially non-volatile solvents which are individually or collectively adapted to penetrate into a treated porous surface derived from wood, a wood derived product such as for example engineered wood or particle board, synthetic surfaces, concrete, cement, brick and the like. Some particularly suitable solvents include, but are not limited to the C₁-C₃ esters of C₁₂-C₁₈ carboxylic acids derived from soybean oil, linseed oil, safflower oil, sunflower oil, peanut oil, fish oil, tall oil, and the like. Based on work completed at this time, soyate based solvents and limonene have proven particularly suitable. Particularly preferred solvents include methyl soyate and d-limonene. Limonene has proven particularly suitable as a low VOC solvent for the inclusion in a concrete or masonry sealer. The preferred compositions developed, at this time, have generally contained from about 10 to about 80 weight percent of a non-aqueous solvent, more preferably from about 30 to about 70 weight percent of the non-aqueous solvent. Compositions based on these solvents, illustrated by the formulations provided below, have provided composition having no VOC's and/or substantially no VOC's and have exhibited elevated flashpoints.

Components of the coating and stain compositions should generally be free of any substantial amounts of antioxidants, such as for example, hydroquinone or hydroquinone derivatives. Hydroquinone and/or its derivatives are commonly components of commercial methyl soyate and its presence in the coating or stain compositions of the present disclosure can interfere with the coating or stain's full incorporation into the treated porous surface through what is believed to be an oxidation process (the curing process). Commercially available limonene typically contains an antioxidant, such as for example, butylated hydroxyanisole (BHA) or butylated hydroxytoluene (BHT).

Preferred UV protectants are derived from non-volatile inorganic compounds. Suitable UV protectants include nanoparticle oxide formulations of titanium, zinc, cerium, cerium, and mixtures thereof. A particularly preferred UV protectant is a nanoparticle version of titanium dioxide. A suitable form is sold under the trade name Hombitec® RM and available from the Sächtleben Chemie GmbH, Postfach 17 04 54, D47184 Duisburg, Germany 4902066220. Hombitec is a registered trademark of Sächtleben Chemie GmbH CORPORATION FED REP GERMANY. Preferred compositions contain the UV protectant metal oxides in amounts ranging from about 0.1 to about 3 weight percent. The utilization of nanoparticle forms of the metal oxides provides long term UV protection without affecting the color, hue, and general appearance of the treated surface. Of course, greater quantities can be utilized, but generally provide little additional advantage.

Suitable driers include generally well-know non-volatile materials such as metal carboxylates. Particularly suitable metal carboxylates include, but are not limited to manganese octoate, cobalt octoate, zirconium octoate, calcium octoate and mixtures thereof. For preferred compositions, the total amount of driers utilized generally ranges from about 0.1 to about 4 weight percent, and more preferably from about 0.5 to about 2 weight percent.

Resins can be added to the compositions to aid in dispersing the solids present and to provide a more hardened surface upon application and curing. Some resins derived from linseed oil, tung oil and the like slowly oxidize upon exposure to air to harden and improve a treated surface's durability and appearance. Resins that have proven particularly useful as components of the compositions of this disclosure include soy oil and linseed oil modified urethane resins, alkyl derivatives of linseed oil, polymethyl methacrylate resins, and the like. One class of preferred soy oil and/or linseed oil modified resins include soy or linseed uralkyd resins. Such uralkyd resins can be prepared from the reaction of a partially saponified fatty acid/polyglyceride ester (sufficient saponification to form a diol), followed by the reaction with a diisocyanate. For stain and wood sealant compositions developed at this time, suitable ranges for one or a combination of resins are from about 1 to about 30 weight percent, more preferably from about 2 to about 20 weight percent. For sealant compositions developed for concrete, suitable ranges for one or a combination of resins are from about 4 to about 60 weight percent, more preferably from about 10 to about 50 weight percent.

Although preferred formulations are substantially free of antioxidants, formulations particularly susceptible to in container oxidation during storage can contain low levels of antioxidants. For this purpose, a preferred anti-oxidant is Doverphos® 4, a trisnonylphenylphosphite, available from ICC Industries has performed well as an anti-oxidant, when used at low levels. For compositions developed at this time, preferred ranged for an anti-oxidant are from about 0.1 to about 2 weight percent, more preferably about 0.5 weight percent. Doverphos is a registered trademark of the Dover Chemical Corporation, 3676 Davis Road N.W., P.O. Box 40 Dover, Ohio 44622.

The preferred compositions of this present disclosure also contain one or more biocides to prevent the growth of molds, algae, and the like that commonly grow on wood and other surfaces. Based on testing completed at this time, a preferred fungicide is Troysan POLYPHASE® (IPBC), (3-iodo-2-propynyl butyl carbamate) available from the Troy Corporation. POLYPHASE is a registered trademark of the Troy Corporation, 72 Eagle Rock Avenue, East Hanover, N.J. 07936. Based on testing completed at this time, a preferred algicide is IRGAROL® algicide available from Ciba Specialty Chemical Corporation. IRGAROL is a registered trademark of Ciba Specialty Chemical Corporation, 540 White Plains Road, Tarrytown, N.Y. 10591. For preferred compositions developed at this time, the combination of fungicide and mildewcide range from about 0.1 to about 5 weight percent of the coating composition.

The compositions described above can be utilized to provide a clear sealant for protecting a variety of porous surfaces. In addition to these clear coatings, compositions can further contain a variety of inorganic and organic pigments to provide a desirable color to the treated surface. Preferred pigments are non-volatile and non-toxic. Pigments typically make up from about 0.1 to about 3 wt. % of the coating compositions of the present disclosure. Inorganic pigments such as the different grades of transparent iron oxide are particularly preferred. For formulations developed at this time, the transparent iron oxides have provided various shades of yellow, red and black. Other color variations can be attained by combinations of these colors or by the utilization of other pigments. Preferably, the particle size of the pigments is less than about 75 nm. The pigments can be organic or inorganic derived, however, inorganic derived are generally preferred. If pigments having the desired particle size are not commercially available, the larger size pigment can ground to the desired size in another oil-based component of the stain or coating and dispersed with the other component. The grinding of pigment in castor oil has proven particularly effective when necessary. The necessary particle size is determined by the porosity of the surface being treated and the coloration desired. Larger particle size pigments can generally be tolerated for compositions used to treat surfaces having larger size pores.

Derivatives of castor oil have also proven effective as cross-linking agents. For example, formulations of dehydrated castor oil of the type produced by Vertellus Performance materials, Inc. and marked under the trade name “CASTUNG” have proven particularly effective. CASTUNG is a registered trademark of Vertellus Performance Materials, 2110 High Point Road, Greensboro, N.C. 27403. Other cross-linking agents capable of reacting with the resin upon application can also be utilized.

### Preparation of Preferred Formulations

### EXAMPLE 1

The components provided in Table I, below, were combined and vigorously agitated for one hour at ambient temperature in a 40 horsepower mixer at a sufficient mixing speed to thoroughly mix and disperse all ingredients and provide a coating composition having an elevated flash point and substantially no VOC's upon application. Depending on the particle size of the available pigments needed, additional grinding in the castor oil can provide pigments having the desired particle size.

TABLE I

| Component | Quantity (pounds) | Weight % |
|---|---|---|
| D-limonene | 246.2 | 59.7 |
| Castoroil | 69.3 | 16.8 |
| Urotuf F-34 | 17.1 | 4.1 |
| Nuplex Alkyd Resin—OPC #6502-100 | 45.4 | 11.0 |
| Polyphase 60B | 1.8 | 0.4 |
| Paraloid Resin—Diamol BR-115 | 17.1 | 4.1 |
| (diluted with d-limonene) | | |
| Cobalt Octoate | 0.8 | 0.2 |
| Manganese Octoate | 2.0 | 0.5 |
| Zirconium Octoate | 4.0 | 1.0 |
| Calcium Octoate | 0.8 | 0.2 |
| Titanium Dioxide | 4.0 | 1.0 |
| Zinc Oxide | 4.0 | 1.0 |

The sealant composition was applied to a porous concrete surface and allowed to air cure for 24 hours to provide a treated concrete article protected from moisture, biocidal attack and from UV damage. The articles original color was maintained through an extended time of periodic exposure to sunlight as is typically experienced by an article placed outdoors.

### EXAMPLE 2

A similar amount of methyl soyate free of any antioxidants was substituted for the D-limonene in the formula provided in Table 1 and twelve (12) pounds of a transparent iron oxide dispersion (in the form of a 40% iron oxide pigment dispersion concentrate) was added to the mixture to provide a stain composition having an elevated flash point and no VOC's upon application to a porous surface. The stain was applied to an article having a porous wooden surface and allowed to air cure for 24 hours to provide a treated stained article protected from moisture, biocidal attack and from UV damage. The articles stained color was maintained through an extended time of periodic exposure to weather and sunlight.

### Application of Coating and Stain Compositions to a Porous Surface

### EXAMPLE 3

Depending on the nature of the surface to be coated, its location, and the surfaces surroundings, a variety of application methods can be utilized to apply the coatings and stains of the present disclosure. For example, brushing, rolling, flooding, spraying, dabbing with a wet adsorbent article and the like can be utilized to apply the coatings and stains of the present disclosure. Because the coatings and stains of this disclosure have VOC's ranging from substantially no VOC's to no VOC's, the compositions can be sprayed in closed interior locations, provided the spray itself does not come in contact with an ignition source or a surface not to be coated. For coating smaller surface areas, regardless of their location, brushing, rolling and dabbing are generally preferred. Surfaces to be coated or stained should be sufficiently free of moisture to allow substantial penetration of the coating or stain into the porous surface. The level of dryness necessary will depend on the nature of the surface being coated. A wood surface should generally be drier than a porous concrete surface for adequate penetration of the coating or stain. Although preferred temperatures for applying the coatings and stains of this disclosure range from about 50° F. to about 90° F., application can be made over a broad range of temperatures ranging from below 32° F. to more than 90° F. For application methods that result in excess coating or stain on the treated surface, the excess coating or stain can be wiped off with an absorbent material after the desire penetration of coating or stain has been achieved. The removal of excess unabsorbed coating or stain can prevent streaking, in the case of stains, and provide a more satisfying surface appearance.

### EXAMPLE 4

The components provided in Table II, below, were combined and vigorously agitated for one hour at ambient temperature in a 40 horsepower mixer at a sufficient mixing speed to thoroughly mix and disperse all ingredients and provide a “wet look” sealant composition having an elevated flash point and substantially no VOC's upon application. Upon curing the sealed concrete had a gloss natural concrete finish that prevented the adsorption of water and dissolved materials. The sealed concrete was protected against damage caused by normal freeze-thaw cycles.

TABLE II

| Component | Quantity (pounds) | Weight % |
|---|---|---|
| D-limonene | 42.8 | 42.8 |
| Dehydrated Castor Oil | 10 | 10 |
| (Castung ® 103 G-H CASTOROIL) | | |
| Urotuf F-34 | 45 | 45 |
| Manganese Octoate | 0.5 | 0.5 |
| Zirconium Octoate | 1.0 | 1.0 |
| Calcium Octoate | 0.2 | 0.2 |
| Ultra Marine Blue | 0.2 | 0.2 |

The composition provided above can additionally contain a UV protectant, a biocide, and additional additives, depending on the specific application.

### EXAMPLE 5

The components provided in Table III, below, were combined and vigorously agitated for one hour at ambient temperature in a 40 horsepower mixer at a sufficient mixing speed to thoroughly mix and disperse all ingredients and provide a “satin look” sealant composition having an elevated flash point and substantially no VOC's upon application. Upon curing the sealed concrete had a reduced gloss natural concrete finish that prevented the adsorption of water and dissolved materials. The sealed concrete was protected against damage caused by normal freeze-thaw cycles.

TABLE III

| Component | Quantity (pounds) | Weight % |
|---|---|---|
| D-limonene | 64.2 | 64.2 |
| Dehydrated Castor Oil | 10 | 10 |
| (Castung ® 103 G-H CASTOROIL) | | |
| Urotuf F-34 | 24.5 | 24.5 |
| Manganese Octoate (12% rare earth) | 0.3 | 0.3 |
| Zirconium Octoate | .6 | 0.6 |
| Calcium Octoate | .2 | 0.2 |
| Ultra Marine Blue | .2 | 0.2 |

The composition provided above can additionally contain a UV protectant, a biocide, and additional additives, depending on the specific application.

A variety of articles can be treated with the sealants, stains, and coatings described herein. Articles suitable for treatment with the formulations described herein can be constructed of wood and wood derived materials which include, but are not limited to wood, engineered wood, and wood products such as particle board, and the like. Such articles constructed of wood derived materials include, but are not limited to, indoor and outdoor furniture, decks, woodwork, cabinetry, buildings, equipment, and the like. Similarly, articles constructed of masonry, concrete, stucco, and/or brick materials can be similarly treated. Such articles include, but are not limited to driveways, patios, buildings, sidewalks, and the like.

While applicant's invention has been described in detail above with reference to specific embodiments, it will be understood that modifications and alterations in embodiments disclosed may be made by those practiced in the art without departing from the spirit and scope of the disclosure. All such modifications and alterations are intended to be covered.

1. A non-aqueous sealant comprising a non-volatile or substantially non-volatile solvent having an elevated flash point (TCC) of at least about 50° C., at least one resin, at least one drier, and a cross-linker, wherein the composition is sufficiently free of antioxidants to allow the composition to cure, forming a non-fluid material upon application and exposure to air.

2. The sealant of claim 1, further comprising a colorant.

3. The sealant of claim 1, wherein the at least one resin is selected from the group consisting of an oil-modified urethane and a linseed oil-modified urethane.

4. The sealant of claim 1, wherein the solvent is limonene.

5. The sealant of claim 1, wherein the at least one drier is a metal salt and the metal is selected from the group consisting of cobalt, manganese, zirconium, calcium, zinc and a combination thereof.

6. The sealant of claim 5, wherein the at least one drier comprises a combination of cobalt octoate, manganese octoate, zirconium octoate, calcium octoate, and zinc oxide.

7. The sealant of claim 1, wherein the cross-linker is a dehydrated castor oil.

8. The sealant of claim 2, wherein:
(a) the solvent is limonene;
(b) the at least one resin is selected from the group consisting of a derivative of linseed oil, a derivative of tung oil, a derivative of soy oil, and a polymethacyrlate resin;
(c) the at least one drier is selected from the group consisting of cobalt octoate; manganese octoate, zirconium octoate, calcium octoate, and zinc oxide; and
(d) the cross-linker is a derivative of castor oil.

9. The sealant of claim 8, wherein the resin is a derivative of linseed oil, specifically a linseed oil modified urethane.

10. The sealant of claim 8, wherein:
(a) the colorant is ultra marine blue;
(b) the cross-linker is a dehydrated castor oil;
(c) the at least one resin is selected from the group consisting of a derivative of linseed oil, a derivative of tung oil, a derivative of soy oil, and a polymethacrylate resin; and
(d) the at least one drier is selected from the group consisting of cobalt octoate, manganese octoate, zirconium octoate, calcium octoate, and zinc oxide.

11. A non-aqueous sealant comprising a non-volatile or substantially non-volatile solvent having an elevated flash point (TCC) of at least about 50° C., a UV protectant, at least one resin, at least one drier, and a biocide, wherein the composition is sufficiently free of antioxidants to allow the composition to cure forming a non-fluid material upon application and exposure to air.

12. The non-aqueous sealant of claim 11, further comprising a pigment.

13. The non-aqueous sealant of claim 12, wherein the solvent is a C₁-C₃ esters of C₁₂-C₁₈ carboxylic acid derived from an oil selected from the group consisting of soybean oil, linseed oil, safflower oil, sunflower oil, peanut oil, fish oil, tall oil, and a combination thereof.

14. The non-aqueous sealant of claim 13, wherein the solvent is C₁-C₃ esters of C₁₂-C₁₈ carboxylic acid derived from soybean oil.

15. The non-aqueous sealant of claim 14, wherein the solvent is methyl soyate.

16. The non-aqueous sealant of claim 12, wherein the solvent is limonene.

17. The non-aqueous sealant of claim 12, wherein the UV protectant is titanium oxide.

18. The non-aqueous sealant of claim 12, wherein the at least one drier is a metal salt and the metal is selected from the group consisting of cobalt, manganese, zirconium, calcium, and zinc.

19. The non-aqueous sealant of claim 18, wherein the at least one drier comprises a combination of cobalt octoate, manganese octoate, zirconium octoate, calcium octoate, and zinc oxide.

20. The non-aqueous sealant of claim 12, wherein the biocide is 3-iodo-2-propynyl butyl carbamate.

21. The non-aqueous sealant of claim 12, wherein:
(a) the solvent is selected from the group consisting of methyl soyate, limonene, and combinations thereof;
(b) the pigment is iron oxide;
(c) the UV protectant is titanium oxide;
(d) the at least one resin is selected from the group consisting of derivatives of linseed oil, tung oil, soy oil, and polymethacyrlate resins;
(e) the at least one drier is selected from the group consisting of cobalt octoate, manganese octoate, zirconium octoate, calcium octoate, and zinc oxide; and
(f) the biocide includes 3-iodo-2-propynyl butyl carbamate.
